(19) United States
(12) Patent Application Publication
(10) Pub. No.: US 2013/0152633 A1
(43) Pub. Date: Jun. 20, 2013

(54) MIRROR FOR CONCENTRATING SOLAR POWER DEVICES

(71) Applicant: REFLEX SPA, Roncade (IT)

(72) Inventor: Luciano Lucatello, Roncade (IT)

(73) Assignee: REFLEX SPA, Roncade (IT)

(21) Appl. No.: 13/763,952

(22) Filed: Feb. 11, 2013

Related U.S. Application Data
(62) Division of application No. 12/601,654, filed on Nov. 24, 2009, now abandoned.

(30) Foreign Application Priority Data
May 25, 2007 (IT) PD2007A000185

(51) Int. Cl. C03C 21/00

(52) U.S. Cl. CPC C03C 21/002
USPC 65/30.14; 65/60.4; 65/30.1

(57) ABSTRACT

A mirror for concentrating solar power devices, associable with a curved supporting panel, which comprises a flat and thin mirror-finished plate which is flexible, as a consequence of a tempering treatment, for complementary shaping, by inflection, with respect to the panel, which is adapted to support and keep the plate inflexed.

### CROSS-REFERENCE TO RELATED APPLICATIONS

This application is a Division of application Ser. No. 12/601654, filed Nov. 24, 2009, which is a US National Stage Application of PCT/EP2008/056105, filed May 19, 2008, which applications are incorporated herein by reference.

### TECHNICAL FIELD

The present invention relates to a mirror for concentrating solar power devices.

### BACKGROUND ART

Currently, concentrating solar power devices have solar mirrors which are composed of a plurality of mirror-finished plates which are curved so as to provide a semicylindrical-parabolic surface which is adapted to reflect the rays of the sun, concentrating them on the collector tube arranged at the rectilinear focal line of such surface.

Such plates are generally made of glass and are rendered reflective by silvering.

The plates are contoured, during their production, so as to have a curvature which is adapted to provide the semicylindrical-parabolic surface of the solar mirror.

Such plates are then generally glued to a series of supporting panels, which are fastened to the supporting frame, which is intended to support and orient the solar mirror obtained by arranging the panels mutually adjacent.

The use of such mirror-finished plates has the drawback that the process for forming them according to the desired curvature is complicated and expensive.

### DISCLOSURE OF THE INVENTION

The aim of the present invention is to obviate this drawback, by providing a mirror, for concentrating solar power devices, whose formation according to the desired curvature is easy and cheaper than that of currently known mirrors.

Within this aim, an object of the invention is to provide a mirror for concentrating solar power devices which is simple, easy to use, and can be manufactured with low costs.

This aim and this and other objects, which will become better apparent hereinafter, are achieved by a mirror for concentrating solar power devices which can be associated with a curved supporting panel, characterized in that it comprises a fiat and thin mirror-finished plate which is flexible, as a consequence of a tempering treatment, for complementary shaping, by inflection, with respect apparent hereinafter, are achieved by a mirror for concentrating solar power devices which can be associated with a curved supporting panel, characterized in that it comprises a flat and thin mirror-finished plate which is flexible, as a consequence of a tempering treatment, for complementary shaping, by inflection, with respect to said panel, which is adapted to support it and keep it inflexed.

### DESCRIPTION OF THE DRAWINGS

Further characteristics and advantages of the invention will become better apparent from the following detailed description of a preferred but not exclusive embodiment of the mirror for concentrating solar power devices according to the invention, illustrated by way of non-limiting example in the accompanying drawings, wherein:

FIG. 1 is a partially sectional enlarged-scale perspective view of a detail of the mirror according to the invention;

FIG. 2 is a view of the application of the mirror according to the invention.

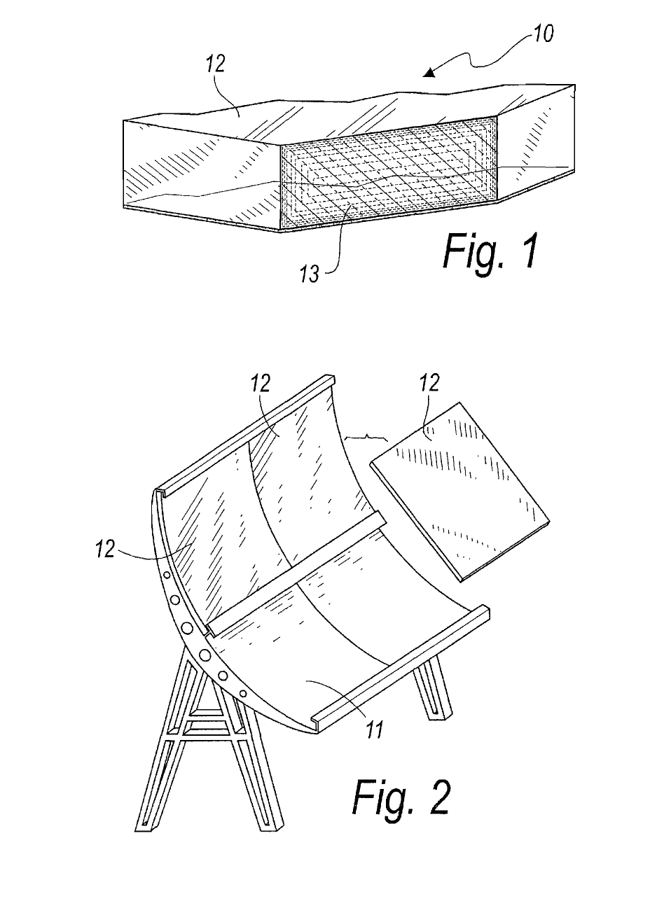

### WAYS OF CARRYING OUT THE INVENTION

It is noted that anything found to be already known during the patenting process is understood not to be claimed and to be the subject of a disclaimer.

With reference to the figures, the reference numeral 10 generally designates a mirror according to the invention for concentrating solar power devices which can be associated with a curved supporting panel 11.

A particularity of the invention is that a mirror-finished plate 12 is flat, thin and flexible, as a consequence of a tempering treatment, for complementary shaping, by inflection, with respect to the panel 11.

By way of tempering, the plate 12 has its surface region 13 pretensioned.

Advantageously, the plate 12 is chemically tempered or, as an alternative, thermally tempered, and has a thickness comprised between 0.6 and 1.8 mm.

The chemically tempered plate 12 conveniently has the surface region 13 which is pretensioned, in a per se known manner, by replacing with potassium ions the sodium ions that are present in the glass of the plate 12. This replacement, as is known, is obtained by immersion in a bath of potassium salts at a temperature higher than 380° C.

The pretensioned surface region 13 thus obtained affects a thickness between 20 and 100 microns in depth from the surface of the plate 12.

The use of the mirror for concentrating solar power devices according to the invention is as follows.

The plate 12 is manufactured flat and subsequently subjected to a tempering and silvering treatment.

In order to be applied to the panel 11, it is deformed elastically until it assumes its shape.

By way of its low thickness, the tensions to which its surface region 13 is subjected during deformation are limited.

Further, by way of the structural modification of the material of which it is composed, induced by tempering, it is adapted to withstand such tensions without breaking.

In practice it has thus been shown that the invention achieves the intended aim and object, by providing a mirror for concentrating solar power devices whose formation according to the desired curvature is easy, since it can be provided by simple elastic deformation of the plate.

Further, a mirror according to the invention is versatile in application, since the mirror-finished plate can be shaped, according to requirements, so as to adapt to surfaces which do not have a predefined shape.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the contingent shapes and dimensions, may be any according to requirements and to the state of the art.

The disclosures in Italian Patent Application No. PD2007A000185 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-6. (canceled)

7. A method for manufacturing a mirror system for concentrating solar power devices, said method comprising:
i) providing a flat and thin glass plate having a thickness between 0.6 and 1.8 mm;
ii) subjecting said flat and thin glass plate to a tempering treatment, so as to define a surface region of said plate that is pre-tensioned, the surface region being a thickness between 20 and 100 microns in depth from a surface of said plate and then to a silvering treatment, to obtain a flat and thin mirror-finished plate which is flexible, as a consequence of said tempering treatment so that the tensions to which said surface region are subjected during elastic deformation are limited due to the thickness of said surface region;
iii) providing a curved supporting panel adapted to support and keep the plate inflexed;
iv) elastically deforming said plate until it assumes the shape of the curved supporting panel limiting;
v) associating, for complementary shaping by inflection with respect to said panel, said flexible flat and thin mirror-finished plate with said curved supporting panel.

8. The method according to claim 7, wherein said plate is tempered chemically.

9. The method according to claim 8, wherein said plate is tempered thermally.

10. The method according to claim 7, wherein the surface region is pre-tensioned by replacing with potassium ions the sodium ions that are present in the glass of the plate.

11. The method according to claim 10, wherein said replacing is obtained by immersion in a bath of potassium salts at a temperature higher than 380° C.
